(19) United States
(12) Patent Application Publication
(10) Pub. No.: US 2025/0131014 A1
(43) Pub. Date: Apr. 24, 2025

(54) DATA PROCESSING METHOD BASED ON ONLINE ANALYTICAL PROCESSING, ELECTRONIC DEVICE AND STORAGE MEDIUM

(71) Applicant: Beijing Volcano Engine Technology Co., Ltd., Beijing (CN)

(72) Inventors: Kejian JU, Beijing (CN); Leilei HU, Beijing (CN); Zhaowei HUANG, Beijing (CN); Yuanpu DING, Beijing (CN)

(21) Appl. No.: 18/885,407

(22) Filed: Sep. 13, 2024

(30) Foreign Application Priority Data
Oct. 24, 2023 (CN) 202311388950.1

(51) Int. Cl. G06F 16/28; G06F 16/22

(52) U.S. Cl. CPC G06F 16/283; G06F 16/2264

(57) ABSTRACT

A data processing method based on online analytical processing, an electronic device and a storage medium are provided. The method includes: receiving a data operation request, wherein the data operation request includes a first field; determining a target associated data pair from a set of associated data pairs stored in a row-based manner based on the data operation request, and determining a second field associated with the first field according to the determined target associated data pair; taking a field value corresponding to the second field in a fact table of a first database as a target field value corresponding to the first field, and executing an operation indicated by the data operation request for the target field value; wherein fields belonging to the second data type among the associated data pairs are stored in the fact table.

### CROSS-REFERENCE TO RELATED APPLICATION(S)

This application claims the priority of Chinese Patent Application No. 202311388950.1 filed on Oct. 24, 2023, and the disclosure of the above-mentioned Chinese Patent Application is hereby incorporated in its entirety by reference as a part of this application.

### TECHNICAL FIELD

Embodiments of the present disclosure relate to the technical field of computers, for example, to a data processing method and apparatus based on online analytical processing, an electronic device and a storage medium.

### BACKGROUND

With the development of computers, users can use electronic devices to realize various functions. For example, users can analyze data through electronic devices.

In some scenarios, Online Analytical Processing (OLAP) system is one of the main applications of data warehouse system, and can be used to support complex analysis operations. OLAP focuses on decision support for decision makers and senior managers, can quickly and flexibly process complex queries with a large amount of data according to the requirements of analysts, and provides query results to decision makers.

### SUMMARY

This section of the present disclosure is provided to introduce concepts in a simplified form, which will be described in detail in the detailed description section later. The present disclosure is not intended to identify key features or essential features of the claimed technical solution, nor is it intended to limit the scope of the claimed technical solution.

An embodiment of the present disclosure provides a data processing method based on online analytical processing, including: receiving a data operation request, wherein the data operation request includes a first field, and the first field belongs to a first data type; determining a target associated data pair from a set of associated data pairs stored in a row-based manner based on the data operation request, and determining a second field associated with the first field according to the determined target associated data pair, wherein the target associated data pair includes the first field and the second field, and the second field belongs to a second data type; and taking a field value corresponding to the second field in a fact table of a first database as a target field value corresponding to the first field, and executing an operation indicated by the data operation request for the target field value; wherein the associated data pair in the set of associated data pairs includes two fields, and the two fields belong to the first data type and the second data type, respectively, and fields belonging to the second data type among the associated data pairs are stored in the fact table to refer to fields belonging to the first data type among the associated data pairs.

An embodiment of the present disclosure further provides a data processing apparatus based on online analytical processing, including: a receiving unit, configured to receive a data operation request, wherein the data operation request includes a first field, and the first field belongs to a first data type; a first determining unit, configured to determine a target associated data pair from a set of associated data pairs stored in a row-based manner based on the data operation request, and determine a second field associated with the first field according to the determined target associated data pair, wherein the target associated data pair includes the first field and the second field, and the second field belongs to a second data type; and an executing unit, configured to take a field value corresponding to the second field in a fact table of a first database as a target field value corresponding to the first field, and execute an operation indicated by the data operation request for the target field value; wherein the associated data pair in the set of associated data pairs comprises two fields, and the two fields belong to the first data type and the second data type, respectively, and fields belonging to the second data type among the associated data pairs are stored in the fact table to refer to fields belonging to the first data type among the associated data pairs.

An embodiment of the present disclosure further provides an electronic device, including one or more processors; and a storage on which one or more programs are stored, wherein the one or more programs, when executed by the one or more processors, are configured to cause the one or more processors to execute the data processing method based on online analytical processing as described above.

An embodiment of the present disclosure further provides a non-transient computer-readable storage medium on which a computer program is stored, wherein the computer program, when executed by a processor, is configured to execute the data processing method based on online analytical processing as described above.

### BRIEF DESCRIPTION OF DRAWINGS

The above and other features, advantages and aspects of the embodiments of the present disclosure will become more apparent from the following detailed description when taken in conjunction with the accompanying drawings. Throughout the drawings, the same or similar reference numerals indicate the same or similar elements. It should be understood that, the drawings are schematic, and the components and elements are not necessarily drawn to scale.

FIG. 1 is a flowchart of an embodiment of a data processing method based on online analytical processing according to the present disclosure;

FIGS. 2, 3 and 4 are schematic diagrams of application scenarios of a data processing method based on online analytical processing according to the present disclosure;

FIG. 5 is a schematic structural diagram of an embodiment of a data processing apparatus based on online analytical processing according to the present disclosure;

FIG. 6 is an exemplary system architecture to which a data processing method based on online analytical processing according to an embodiment of the present disclosure can be applied; and

FIG. 7 is a schematic diagram of a basic structure of an electronic device provided according to an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth herein, but rather, these embodiments are provided for a more thorough and complete understanding of the present disclosure. It should be understood that the drawings and embodiments of the present disclosure are only used for illustrative purposes, and are not used to limit the scope of protection of the present disclosure.

It should be understood that the steps described in the method embodiments of the present disclosure may be performed in a different order and/or in parallel. Furthermore, the method embodiments may include additional steps and/or omit performing the illustrated steps. The scope of the present disclosure is not limited in this respect.

As used herein, the term “comprising/including” and its variants are open-ended inclusion, that is, “comprising/including but not limited to”. The term “based on” is “at least partially based on”. The term “an/one embodiment” means “at least one embodiment”; the term “another embodiment” means “at least one other embodiment”; the term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modifiers such as “a/an” and “a plurality of” mentioned in the present disclosure are schematic rather than limitative, and those skilled in the art should understand that unless the context clearly indicates otherwise, they should be understood as “one or more”.

Names of messages or information exchanged among multiple devices in the embodiments of the present disclosure are only used for illustrative purposes, and are not used to limit the scope of these messages or information.

In one or more embodiments of the present disclosure, OLAP analysis often uses aggregation and correlation analysis. In the case of string type field, the speed of constructing a hash table and sorting the array (for example, by using a Sort function) is slower than that of the numerical type field because of the problem involved in the storage form of strings. The length of numerical type field is relatively fixed, which is easy to hit the cache space of CPU. In actual business scenarios, string type fields are often used, especially when strings with high cardinality are involved. Therefore, when OLAP analysis is applied, various ways can be utilized to associate the string field (for example, name) in the business scene with the mapping of the numerical type field (for example, id) in the fact table, so that the string field can be processed after associating with the fact table.

In one or more embodiments of the present disclosure, a row-based table can be used as a dimension table, and a fact table can be field-coded, so that a string type field can be converted into a numerical type field. Row-based table can completely or partly adopt a row-based storage. When a row-based table partly adopts a row-based storage, it can also be referred to as a row-column mixed storage table. The row-based table has high ability of point query and point update, so it can respond quickly to the data update with small range and high QPS. At the same time, when querying, if the list operator needs a global dictionary, it can carry out a point query outside the fact table to avoid constructing a hash table. For example, in the case of aggregate query or associate query, it can directly use the row-based table to carry out the point query.

In one or more embodiments of the present disclosure, a row-based table can be implemented in a fact table of the OLAP database, and the associated string type field and numerical type field can be stored in the row-based table.

In one or more embodiments of the present disclosure, a database cluster with ability of high-frequency point update and point query can be integrated in the form of an external table of OLAP database. The data of the external table is not stored in the database. Due to the external data storage of the external table, that is, due to the storage-compute decoupling mode, it is convenient to handle the computational scheduling without binding specific computational nodes. When less structured data is used outside the database, the processing speed can be improved by using the external table.

In one or more embodiments of the present disclosure, the numerical type field can be generated by way of manual assignment or by way of auto-increment column. An auto-increasement column is a column in the database whose value increases automatically with each row inserted. In this way, every time a row is added, the value of the field will automatically increase without assignment and it is unique. Auto-increment columns are monotonically increasing, which is friendly for creating indexes. Auto-increment columns can be applied to integer data columns.

In one or more embodiments of the present disclosure, the fact table of the database may take the form of column-based storage.

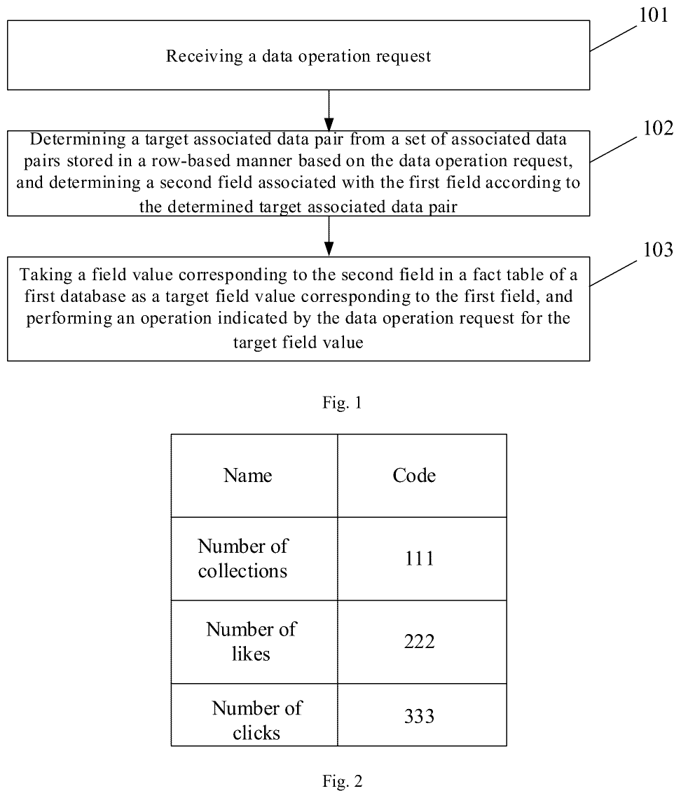

Referring to FIG. 1, which shows the flow of an embodiment of a data processing method based on online analytical processing according to the present disclosure. As shown in FIG. 1, the data processing method based on online analytical processing includes the following steps.

Step 101, receiving a data operation request.

In this embodiment, an execution subject (such as a server and/or a terminal device) of the data processing method based on online analytical processing can receive a data operation request.

Here, the data operation request can be used to request for an operation on the data in the database. The operation type of the above operation is not limited, for example, it can be any type of adding, deleting, modifying and querying.

Here, the data operation request may include a first field. The first field belongs to the first data type. The data operation request may be used to request for an operation on the first field. Optionally, the data operation request may include a video identifier, and the data operation request may be used to request for an operation on the field value of the first field of the video indicated by the video identifier.

As an example, the first field may be the number of likes, and the first field may be a string type.

As an example, when the data in the database is stored, if the field type is string type, the speed of constructing a hash table and sorting the array (for example, by using a Sort function) is slower than that of the numerical type field because of the problem involved in the storage form of strings. The length of numerical type field is relatively fixed, which is easy to hit the cache space of CPU. Therefore, the numerical type field can be used in the database to represent the string field in the business scenario to improve the performance of storage, reading and writing.

As an example, a data operation request includes a first field of a first data type, so it needs to be mapped to a database to determine an associated second field (belonging to a second data type, such as a numerical type), and then located to a field value indicated by the data operation request.

As an example, the first data type may be a string type and the second data type may be a numerical type.

Step 102, determining a target associated data pair from a set of associated data pairs stored in a row-based manner based on the data operation request, and determining a second field associated with the first field according to the determined target associated data pair.

Here, it can pre-construct associated data pairs to associate the string fields (such as names) in business scenarios with the mappings of the numerical type fields (such as codes) in fact tables, and form a set of associated data pairs. One or more associated data pairs can be included in the set of associated data pairs.

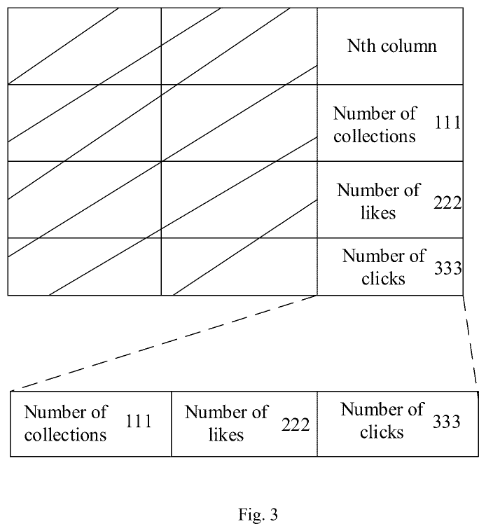

As an example, referring to FIG. 2, which shows a set of associated data pairs. FIG. 2 shows three associated data pairs. A first associated data pair includes the number of collections and 111, where the number of collections is a first type field and 111 is a second type field. A second associated data pair includes the number of likes and 222, where the number of likes is a first type field and 222 is a second type field. A third associated data pair includes the number of clicks and 333, where the number of clicks is a first type field and 333 is a second type field.

In some scenarios, when OLAP is used for analysis, the numerical type field in the fact table corresponding to the string field in the business scenario can be determined through the correlation relationship indicated by the associated data pair, and then the corresponding field value can be determined.

Here, the target association data pair includes a first field and a second field. The first field belongs to the first data type and the second field belongs to the second data type.

Here, the second type field is the storage form of the first type field in the fact table of the database.

Here, the associated data pair in the set of associated data pairs includes two fields, which belong to the first data type and the second data type respectively; the fields belonging to the second data type among the associated data pairs are stored in the fact table to refer to the fields belonging to the first data type among the associated data pairs. That is, the associated data pair in the set of associated data pairs may include two fields. One of these two fields belongs to the first data type and the other belongs to the second data type. Fields in the business scenario can be of the first data type, and fields of the second data type can be stored in the fact table of the database.

Here, the above-mentioned set of associated data pairs can be stored in a row-based manner. Row-based storage can organize data in the form of rows. In contrast, column-based storage can organize data in the form of columns. In some scenarios, the difference between row-based storage and column-based storage lies in whether row data or column data is stored in one tuple.

In some scenarios, the set of associated data pairs stored in a row-based manner has high ability of point query and point update, and can respond quickly to data updates with small range and high QPS.

Step 103, taking a field value corresponding to the second field in a fact table of a first database as a target field value corresponding to the first field, and performing an operation indicated by the data operation request for the target field value.

In this embodiment, the fact table may include a plurality of fields of the second data type. The execution subject can determine the second field from the fact table according to the second field in the target associated data pair, and take the field value corresponding to the second field as the target field value. The target field value then is taken as the target field value corresponding to the first field. Moreover, the operation indicated by the data operation request (such as adding, deleting, modifying and querying) can be performed for the target field value.

Fact table, a table stored with fact records, mainly records data or indicators in specific business processes, such as sales order, customer order quantity, sales amount, profit and the like. A fact table generally contains a large amount of data, which will grow continuously with time, and supports various calculation methods, such as summation and averaging. The data in the fact table can be associated with a dimension table to generate a data model with multi-dimensional decision analysis, and support flexible query methods, such as data cutting and aggregation according to time dimension, location dimension and product dimension. For example, in sales business, the fact table may include order tables, transaction tables, delivery tables, customer feedback tables, etc.

It should be noted that, in the data processing method provided by this embodiment, a set of associated data pairs including fields of a first data type and fields of a second data type and stored in a row-based manner is pre-constructed; a target associated data pair including a first field is determined from the set of associated data pairs stored in a row-based manner in response to receiving a data operation request including the first field, and then a second field associated with the first field is determined based on the determined target associated data pair; fields of the second data type are stored in a fact table of a first database to refer to fields of the first data type, and a field value corresponding to the second field in the fact table of the first database is taken as a target field value of the first field. Therefore, a new storage mode of the associated data pairs can be provided, and the querying speed for the target associated data pair can be improved, so that the target field value corresponding to the data operation request can be quickly determined and the operation speed can be improved.

In contrast, in some related technologies, the cost for associating actions (by using a join function) in a querying operation is relatively expensive, especially in the case of data skew, which is prone to cause performance bottleneck. When updating the event table, it is necessary to associate the event table with a global dictionary. In this way, the writing performance is greatly affected, resulting in low writing efficiency, that is, writing performance is sacrificed for reading performance.

In some embodiments, the above-mentioned set of associated data pairs can be stored in any location that can be obtained by the execution subject. As an example, the set of associated data pairs can be stored in a dimension table and/or a fact table of the database.

In some embodiments, the set of associated data pairs is stored in the fact table of a first database.

Here, the above-mentioned fact table may be a row-based table, a column-based table, or a row-column mixed storage table. The set of associated data pairs stored in the fact table can be stored in a row-based manner.

It should be noted that, when the set of associated data pairs is stored in the fact table, it enables quickly determining the second field in the process of operating the fact table, reducing the reading of different tables in the database and improving the querying speed.

In some embodiments, the fact table stores data in a column-based manner, and the associated data pairs in the set of associated data pairs are stored in the same column of the fact table. Any associated data pair in the set of associated data pairs is stored in the same row and the same column of the fact table, or is stored in adjacent rows and the same column of the fact table.

Here, the above-mentioned fact table may be a column-based table. The row-based storage of the set of associated data pairs in the fact table can be implemented by way of column-based storage. As an example, two fields in an associated data pair can be stored in the same row and the same column, or in different rows and the same column, to realize row-based storage in a column-based table.

As an example, reference can be made to FIG. 3 and FIG. 4.

FIGS. 3 and 4 show examples of fact tables, in which the shaded part at the left side is stored with fact data. The Nth column of the fact table can be stored with a set of associated data pairs. Various associated data pairs in the set of associated data pairs can be stored in the same column.

In FIG. 3, the associated data pair can be located in the same row and the same column. In FIG. 4, the associated data pair can be located in adjacent rows and the same column.

When column-based storage is implemented in the Nth column shown in FIG. 3 and FIG. 4, reference can be made to FIG. 2, which can realize the row-based storage of associated data pairs, that is, the arrangement is in the order of the number of collections, 111, the number of likes, 222, the number of clicks, and 333. For a clearer explanation, reference can be made to the example in FIG. 2, if the set of associated data pairs is stored in a column-based manner, the storage result will be the arrangement in the order of the number of collections, the number of likes, the number of clicks, 111, 222, and 333.

It can be understood that the ways of realizing row-based storage in FIGS. 3 and 4 can be applied not only to fact tables, but also to dimension tables or separate, associated field storage tables.

Therefore, a new way can be provided, which allows the set of associated data pairs to be still stored in a row-based manner even when the fact table mainly adopts the manner of column-based storage, thereby improving the querying speed.

In some embodiments, the associated data pairs are stored in a row-based manner in an embedded table of the fact table.

The embedded table of a fact table can store data in a row-based manner. That is, the associated data pairs in the embedded table are stored in a row-based manner in the embedded table of the fact table.

Therefore, in the process of updating the set of associated data pairs, the influence on the data in the fact table can be reduced, and the security of the data in the fact table of the database can be improved.

In some embodiments, the method further includes: determining a target associated data pair from the set of associated data pairs based on a preset encoding mapping function and the first field, and determining the second field associated with the first field according to the determined target associated data pair.

Here, an encoding mapping function can be used to map the fields of the second data type to the fields of the first data type. As an example, the encoding mapping function may include a dictmap function.

As an example, the dictmap function can be used to obtain an encoding mapping of the first field from a row-based table or a row-column mixed storage table (in which a set of associated data pairs is stored).

In some embodiments, the set of associated data pairs is stored in a dimension table of a first database.

Dimension table is a table describing the background information of business facts, which mainly records various dimension attributes in business facts, such as time, place, products, customers and other information in specific business fields. A dimension table generally has relatively stable data contents, and the data therein will not change frequently. For example, in sales business, a dimension table may include a time dimension table, a location dimension table, a product dimension table and a customer dimension table. Dimension table can provide support for business analysis and help to realize multi-dimensional data analysis and data mining.

In this way, since the dimension table is generally not bound to specific computational nodes for computational scheduling, the storage and computation are decoupled, which makes it easier to implement. Moreover, by storing the set of associated data pairs in the dimension table, it can reduce the probability of updating the fact table and improve the security of the fact table.

In some embodiments, the method further includes: determining a target associated data pair from the dimension table according to a preset acquisition function and the first field, and determining the second field associated with the first field according to the determined target associated data pair.

Here, a preset acquisition function (such as a get function) can be used to determine the second field associated with the first field from the dimension table; it is faster to use the acquisition function to acquire a value from the dimension table, which can improve the speed of determining the second field, thus improving the operation speed.

In some embodiments, among the associated data pairs in the set of associated data pairs, the fields of the second data type can be generated by an auto-increasement column function.

Here, the auto-increasement column function can realize a column whose value in the table automatically increases with each row inserted. In this way, every time a row is added, a value of the field will automatically increase without assignment and the value is unique.

Therefore, the associated data pair can be generated without manual operation, and when a new field of the first data type is inserted, this new field of the first data type can be automatically assigned with a unique field of the second data type by means of the auto-increment column function. In this way, the operation time of personnel can be saved and the efficiency of generating the set of associated data pairs can be improved.

In some embodiments, the storage carrier of the set of associated data pairs is an external table of the first database. In other words, the storage carrier of the set of associated data pairs is located in the external table of the first database.

Here, the storage carrier of the set of associated data pairs can be a dimension table or a fact table. The storage carrier may be located in the external table of the first database, and the first database has no management authority over the external table of the first database. In other words, the set of associated data pairs can be stored in a medium that the first database has management authority, or in a medium that the first database does not have management authority.

It should be noted that when the set of associated data pairs is stored in an external table, for the scenario where multiple databases form a database cluster, it is possible to store one set of associated data pairs for multiple databases to use, thus reducing the storage of duplicate data and improving the storage efficiency.

In some embodiments, the step 102 may include: judging whether the data operation request belongs to a request based on point query; if the data operation request belongs to a request based on point query, determining the target associated data pair from the set of associated data pairs stored in a row-based manner.

The request of point query type can refer to the query of data within a preset threshold number of pieces of data. The request based on point query can include: operating the queried data in the case of request based on point query.

Optionally, if the data operation request does not belong to a request based on point query, the above-mentioned data operation request can be executed by joining with a global dictionary.

Here, the request of point query type can instruct to query a small batch of data. When the associated data pairs are stored in a row-based manner, it can realize rapid response in the scenario of point query, that is, in the scenario of updating a small batch of data.

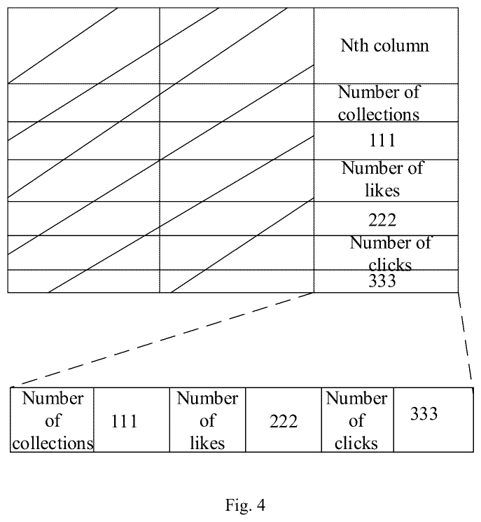

Further, referring to FIG. 5, as an implementation of the method shown in the above figures, the present disclosure provides an embodiment of a data processing apparatus based on online analytical processing, which corresponds to the method embodiment shown in FIG. 1, and can be applied to various electronic devices.

As shown in FIG. 5, the data processing apparatus based on online analytical processing in this embodiment includes a receiving unit 501, a first determining unit 502 and an executing unit 503. The receiving unit is configured to receive a data operation request, wherein the data operation request includes a first field, and the first field belongs to a first data type; a first determining unit, configured to determine a target associated data pair from a set of associated data pairs stored in a row-based manner based on the data operation request, and determine a second field associated with the first field according to the determined target associated data pair, wherein the target associated data pair includes the first field and the second field, and the second field belongs to a second data type; the executing unit is configured to take a field value corresponding to the second field in a fact table of a first database as a target field value corresponding to the first field, and execute an operation indicated by the data operation request for the target field value; wherein the associated data pair in the set of associated data pairs includes two fields, and the two fields belong to the first data type and the second data type respectively; fields belonging to the second data type among the associated data pairs are stored in the fact table to refer to fields belonging to the first data type among the associated data pairs.

In this embodiment, the specific processes of the receiving unit 501, the first determining unit 502 and the executing unit 503 of the data processing apparatus based on online analytical processing and the technical effects brought by them can refer to the related descriptions of steps 101, 102 and 103 in the corresponding embodiment of FIG. 1 respectively, and will not be repeated here.

In some embodiments, the set of associated data pairs is stored in the fact table of the first database.

In some embodiments, the fact table stores data in a column-based manner, and the associated data pairs in the set of associated data pairs are stored in a same column of the fact table, and any associated data pair in the set of associated data pairs is stored in a same row and a same column or in adjacent rows and a same column of the fact table.

In some embodiments, the associated data pair is stored in a row-based manner in an embedded table of the fact table.

In some embodiments, determining the target associated data pair from the set of associated data pairs stored in a row-based manner based on the data operation request, and determining the second field associated with the first field according to the determined target associated data pair, including: determining the target associated data pair from the set of associated data pairs based on a preset encoding mapping function and the first field, and determining the second field associated with the first field according to the determined target associated data pair.

In some embodiments, the set of associated data pairs is stored in a dimension table of the first database.

In some embodiments, the apparatus is further configured to determine the target associated data pair from the dimension table according to a preset acquisition function and the first field, and determine the second field associated with the first field according to the determined target associated data pair.

In some embodiments, the fields belonging to the second data type in the set of associated data pairs are generated by an auto-increasement column function.

In some embodiments, a storage carrier of the set of associated data pairs is an external table of the first database.

In some embodiments, determining the target associated data pair from the set of associated data pairs stored in a row-based manner based on the data operation request includes: judging whether the data operation request belongs to a request based on point query; if the data operation request belongs to a request based on point query, determining the target associated data pair from the set of associated data pairs stored in a row-based manner.

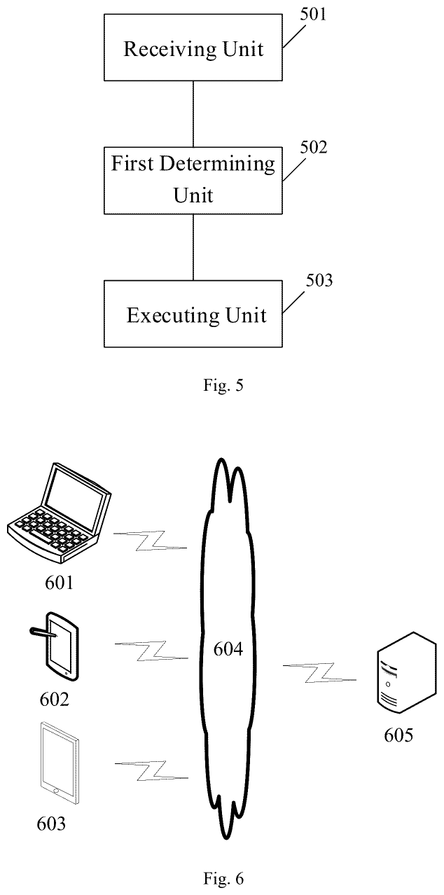

Referring to FIG. 6, which shows an exemplary system architecture to which the data processing method based on online analytical processing according to an embodiment of the present disclosure can be applied.

As shown in FIG. 6, the system architecture may include terminal devices 601, 602 and 603, a network 604 and a server 605. The network 604 is a medium for providing communication links between the terminal devices 601, 602, 603 and the server 605. Network 604 may include various connection types, such as wired and wireless communication links or fiber optic cables.

Terminal devices 601, 602, and 603 can interact with the server 605 through the network 604 to receive or send messages, etc. Various client applications can be installed on the terminal devices 601, 602 and 603, such as web browser applications, search applications and news information applications. Client applications in the terminal devices 601, 602, and 603 can receive user's instructions and complete corresponding functions according to the user's instructions, such as adding corresponding information to information according to the user's instructions.

The terminal devices 601, 602 and 603 may be hardware or software. When the terminal devices 601, 602, and 603 are hardware, they can be various electronic devices with display screens and supporting web browsing, including but not limited to smart phones, tablet computers, e-book readers, MP3 players (Moving Picture Experts Group Audio Layer III), MP4 (Moving Picture Experts Group Audio Layer IV) players, laptop computers, desktop computers and so on. When the terminal devices 601, 602 and 603 are software, they can be installed in the electronic devices listed above. It can be implemented as multiple software or software modules (for example, to provide distributed services) or implemented as a single software or software module. It is not specifically limited here.

The server 605 can provide various services, such as receiving information acquisition requests sent by the terminal devices 601, 602, and 603, and acquiring exhibition information corresponding to the information acquisition requests through various ways according to the information acquisition requests. The relevant data of the exhibition information is sent to the terminal devices 601, 602 and 603.

It should be noted that the data processing method based on online analytical processing provided by the embodiment of the present disclosure can be executed by the terminal devices, and correspondingly, the data processing apparatus based on online analytical processing can be arranged in the terminal devices 601, 602 and 603. In addition, the data processing method based on online analytical processing provided by the embodiment of the present disclosure can also be executed by the server 605, and correspondingly, the data processing apparatus based on online analytical processing can be installed in the server 605.

It should be understood that, the number of terminal devices, network and server in FIG. 6 are only schematic. There can be any number of terminal devices, networks and servers according to the needs of implementation.

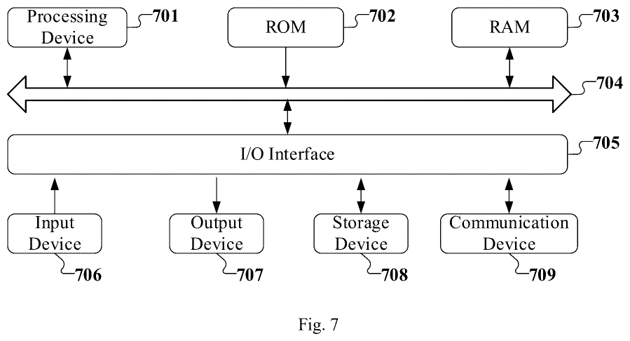

Reference is now made to FIG. 7, which shows a schematic structural diagram of an electronic device (such as a terminal device or a server in FIG. 6) suitable for implementing an embodiment of the present disclosure. The terminal devices in the embodiment of the present disclosure may include, but are not limited to, mobile terminals such as mobile phones, notebook computers, digital broadcast receivers, PDA (Personal Digital Assistant), PAD (Tablet Computer), PMP (Portable Multimedia Player), vehicle-mounted terminals (such as vehicle-mounted navigation terminals), and fixed terminals such as digital TV and desktop computers. The electronic device shown in FIG. 7 is only an example, and should not bring any limitation to the function and application scope of the embodiment of the present disclosure.

As shown in FIG. 7, the electronic device may include a processing device (such as a central processing unit, a graphics processor, etc.) 701, which may perform various appropriate actions and processes according to a program stored in a read-only memory (ROM) 702 or a program loaded from a storage device 708 into a random-access memory (RAM) 703. In the RAM 703, various programs and data required for the operations of the electronic device 700 are also stored. The processing device 701, the ROM 702 and the RAM 703 are connected to each other through a bus 704. An input/output (I/O) interface 705 is also connected to the bus 704.

Generally, the following devices can be connected to the I/O interface 705: an input device 706 including, for example, a touch screen, a touch pad, a keyboard, a mouse, a camera, a microphone, an accelerometer, a gyroscope, etc.; an output device 707 including, for example, a liquid crystal display (LCD), a speaker, a vibrator, etc.; a storage device 708 including, for example, a magnetic tape, a hard disk, etc.; and a communication device 709. The communication device 709 may allow the electronic device to communicate with other devices wirelessly or in a wired manner to exchange data. It should be understood that, although FIG. 7 shows an electronic device with various devices, it is not required to implement or have all the devices as shown. More or fewer devices may alternatively be implemented or provided.

In particular, according to an embodiment of the present disclosure, the processes described above with reference to the flowchart can be implemented as a computer software program. For example, an embodiment of the present disclosure includes a computer program product including a computer program carried on a non-transitory computer-readable medium, which contains program codes for executing the method shown in the flowchart. In such an embodiment, the computer program can be downloaded and installed from the network through the communication device 709, or installed from the storage device 708, or installed from the ROM 702. When the computer program is executed by the processing device 701, the above functions defined in the method of the embodiments of the present disclosure are performed.

It should be noted that the computer-readable medium mentioned above in the present disclosure can be a computer-readable signal medium or a computer-readable storage medium or any combination of both. The computer-readable storage medium can be, for example, but not limited to, an electrical, magnetic, optical, electromagnetic, infrared, or semiconductor system, apparatus or device, or a combination of any of the above. More specific examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, apparatus or device. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program code contained in the computer-readable medium can be transmitted by any suitable medium, including but not limited to: wires, optical cables, RF (radio frequency) and the like, or any suitable combination of the above.

In some embodiments, the client and the server can communicate by using any currently known or future developed network protocol such as HTTP (HyperText Transfer Protocol), and can be interconnected with digital data communication in any form or medium (for example, communication network). Examples of communication networks include a local area network (“LAN”), a wide area network (“WAN”), the Internet (for example, the Internet) and end-to-end networks (for example, ad hoc end-to-end networks), as well as any currently known or future developed networks.

The computer-readable medium may be included in the electronic device; or it can exist alone without being assembled into the electronic device.

The computer-readable medium carries one or more programs, which, when executed by the electronic device, cause the electronic device to: receive a data operation request, wherein the data operation request includes a first field, and the first field belongs to a first data type; determine a target associated data pair from a set of associated data pairs stored in a row-based manner based on the data operation request, and determine a second field associated with the first field according to the determined target associated data pair, wherein the target associated data pair includes the first field and the second field, and the second field belongs to a second data type; take a field value corresponding to the second field in a fact table of a first database as a target field value corresponding to the first field, and execute an operation indicated by the data operation request for the target field value; wherein the associated data pair in the set of associated data pairs includes two fields, and the two fields belong to the first data type and the second data type respectively; fields belonging to the second data type among the associated data pairs are stored in the fact table to refer to fields belonging to the first data type among the associated data pairs.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in an order different from those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of various blocks in the block diagrams and/or flowcharts, can be implemented by a dedicated hardware-based system that performs specified functions or operations, or by a combination of dedicated hardware and computer instructions.

The units involved in the embodiments described in the present disclosure can be realized by software or hardware. Among them, the name of the unit does not constitute any limitation of the unit itself in some cases. For example, the receiving unit can also be described as “the unit that receives the data operation request”.

The functions described above may be at least partially performed by one or more hardware logic components. For example, exemplary types of hardware logic components that can be used include, but not limited to: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more lines, a portable computer disk, a hard disk, a random-access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

The above description is only the exemplary embodiments of the present disclosure and the explanation of the applied technical principles. It should be understood by those skilled in the art that the disclosure scope involved in the present disclosure is not limited to the technical solution formed by the specific combination of the above technical features, but also covers other technical solutions formed by any combination of the above technical features or their equivalent features without departing from the above disclosure concept. For example, technical solutions formed by replacing the above features with (but not limited to) technical features having similar functions disclosed in the present disclosure.

Furthermore, although the operations are depicted in a particular order, this should not be understood as requiring that these operations be performed in the particular order as shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. A data processing method based on online analytical processing, comprising:
receiving a data operation request, wherein the data operation request comprises a first field, the first field belongs to a first data type, and the first data type comprises a string data type;
determining a target associated data pair from a set of associated data pairs stored in a row-based manner based on the data operation request, and determining a second field associated with the first field comprised in the data operation request according to the determined target associated data pair, wherein the target associated data pair comprises the first field and the second field, wherein the second field belongs to a second data type, and wherein the second data type comprises a numerical data type representative of the string data type;
taking a numerical code corresponding to the second field in a fact table of a first database as a target field value representative of the first field, wherein the fact table is field-coded to enable data of the first data type to be converted into the second data type; and
executing an operation indicated by the data operation request for the target field value;
wherein the target associated data pair in the set of associated data pairs comprises two fields, and the two fields belong to the first data type and the second data type, respectively, and fields belonging to the second data type among the associated data pairs are stored in the fact table to refer to fields belonging to the first data type among the associated data pairs in the set of associated data pairs.

2. The method according to claim 1, wherein the set of associated data pairs is stored in the fact table of the first database.

3. The method according to claim 2, wherein the fact table stores data in a column-based manner, the associated data pairs in the set of associated data pairs are stored in a same column of the fact table, and any associated data pair in the set of associated data pairs is stored in a same row and the same column of the fact table or stored in adjacent rows and the same column of the fact table.

4. The method according to claim 2, wherein the associated data pairs are stored in a row-based manner in an embedded table of the fact table.

5. The method according to claim 2, wherein determining the target associated data pair from the set of associated data pairs stored in a row-based manner based on the data operation request, and determining the second field associated with the first field according to the determined target associated data pair, comprising:
determining the target associated data pair from the set of associated data pairs based on a preset encoding mapping function and the first field, and determining the second field associated with the first field according to the determined target associated data pair.

6. The method according to claim 1, wherein the set of associated data pairs is stored in a dimension table of the first database.

7. The method according to claim 6, further comprising:
determining the target associated data pair from the dimension table according to a preset acquisition function and the first field, and determining the second field associated with the first field according to the determined target associated data pair.

8. The method according to claim 1, wherein the fields belonging to the second data type in the set of associated data pairs are generated by an auto-increment column function.

9. The method according to claim 1, wherein a storage carrier of the set of associated data pairs is an external table of the first database.

10. The method according to claim 1, wherein determining the target associated data pair from the set of associated data pairs stored in a row-based manner based on the data operation request comprises:
judging whether the data operation request belongs to a request based on point query;
in response to the data operation request belonging to a request based on point query, determining the target associated data pair from the set of associated data pairs stored in a row-based manner.

11. An electronic device, comprising:
one or more processors; and
a storage for storing one or more programs, wherein
the one or more programs, when executed by the one or more processors, are configured to cause the one or more processors to execute a data processing method based on online analytical processing, comprising:
receiving a data operation request, wherein the data operation request comprises a first field, the first field belongs to a first data type, and the first data type comprises a string data type;
determining a target associated data pair from a set of associated data pairs stored in a row-based manner based on the data operation request, and determining a second field associated with the first field comprised in the data operation request according to the determined target associated data pair, wherein the target associated data pair comprises the first field and the second field, wherein the second field belongs to a second data type, and wherein the second data type comprises a numerical data type representative of the string data type;
taking a numerical code corresponding to the second field in a fact table of a first database as a target field value representative of the first field, wherein the fact table is field-coded to enable data of the first data type to be converted into the second data type; and
executing an operation indicated by the data operation request for the target field value;
wherein the target associated data pair in the set of associated data pairs comprises two fields, and the two fields belong to the first data type and the second data type, respectively, and fields belonging to the second data type among the associated data pairs are stored in the fact table to refer to fields belonging to the first data type among the associated data pairs in the set of associated data pairs.

12. The electronic device according to claim 11, wherein in the data processing method, the set of associated data pairs is stored in the fact table of the first database.

13. The electronic device according to claim 12, wherein in the data processing method, the fact table stores data in a column-based manner, the associated data pairs in the set of associated data pairs are stored in a same column of the fact table, and any associated data pair in the set of associated data pairs is stored in a same row and the same column of the fact table or stored in adjacent rows and the same column of the fact table.

14. The electronic device according to claim 12, wherein in the data processing method, the associated data pairs are stored in a row-based manner in an embedded table of the fact table.

15. The electronic device according to claim 12, wherein in the data processing method, determining the target associated data pair from the set of associated data pairs stored in a row-based manner based on the data operation request, and determining the second field associated with the first field according to the determined target associated data pair, comprising:
determining the target associated data pair from the set of associated data pairs based on a preset encoding mapping function and the first field, and determining the second field associated with the first field according to the determined target associated data pair.

16. The electronic device according to claim 11, wherein in the data processing method, the set of associated data pairs is stored in a dimension table of the first database.

17. The electronic device according to claim 16, wherein the data processing method further comprises:
determining the target associated data pair from the dimension table according to a preset acquisition function and the first field, and determining the second field associated with the first field according to the determined target associated data pair.

18. The electronic device according to claim 11, wherein in the data processing method, the fields belonging to the second data type in the set of associated data pairs are generated by an auto-increment column function.

19. The electronic device according to claim 11, wherein determining the target associated data pair from the set of associated data pairs stored in a row-based manner based on the data operation request comprises:
judging whether the data operation request belongs to a request based on point query;
in response to the data operation request belonging to a request based on point query, determining the target associated data pair from the set of associated data pairs stored in a row-based manner.

20. A non-transient computer-readable storage medium on which a computer program is stored, wherein the computer program, when executed by a processor, is configured to execute a data processing method based on online analytical processing, comprising:
receiving a data operation request, wherein the data operation request comprises a first field, the first field belongs to a first data type, and the first data type comprises a string data type;
determining a target associated data pair from a set of associated data pairs stored in a row-based manner based on the data operation request, and determining a second field associated with the first field comprised in the data operation request according to the determined target associated data pair, wherein the target associated data pair comprises the first field and the second field, wherein the second field belongs to a second data type, and wherein the second data type comprises a numerical data type representative of the string data type;
taking a field value numerical code the second field in a fact table of a first database as a target field value corresponding to representative of the first field, wherein the fact table is field-coded to enable data of the first data type to be converted into the second data type; and
executing an operation indicated by the data operation request for the target field value;
wherein the target associated data pair in the set of associated data pairs comprises two fields, and the two fields belong to the first data type and the second data type, respectively, and fields belonging to the second data type among the associated data pairs are stored in the fact table to refer to fields belonging to the first data type among the associated data pairs in the set of associated data pairs.
